(19) United States
(12) Patent Application Publication
(10) Pub. No.: US 2025/0053743 A1
(43) Pub. Date: Feb. 13, 2025

(54) LANGUAGE AND SENTIMENT ANALYSIS FOR GENERATING SUPPORT SUMMARIES

(71) Applicant: Insight Direct USA, Inc., Chandler, AZ (US)

(72) Inventors: Jason Rader, Jacksonville, FL (US); David McCurdy, Centennial, CO (US)

(21) Appl. No.: 18/790,398

(22) Filed: Jul. 31, 2024

Related U.S. Application Data
(60) Provisional application No. 63/531,141, filed on Aug. 7, 2023.

(51) Int. Cl. G06F 40/284; G06F 40/30

(52) U.S. Cl. CPC G06F 40/284; G06F 40/30

(57) ABSTRACT

A method of generating a support summary includes extracting chat information including natural language data from a support chat with a user. Tokenized language is generated by performing feature extraction on this natural language data. This tokenized language is subjected to sentiment analysis to produce sentiment data reflecting sentiment of the support user during the support chat, and to semantic analysis to extract support-relevant features. A support summary made up of natural language text identifying a support issue and information germane to the support issue is then generated from the extracted chat information using a language model, at least in part from the extracted support-relevant features and the sentiment data.

### CROSS-REFERENCE TO RELATED APPLICATION

The present application claims priority to U.S. Provisional Application No. 63/531,141 filed Aug. 7, 2023 for “LANGUAGE AND SENTIMENT ANALYSIS FOR GENERATING SUPPORT SUMMARIES” by J. Rader, the disclosure of which is incorporated in its entirety by reference herein.

### FIELD OF THE INVENTION

The present disclosure relates generally to language processing, and more particularly to the generation and distillation of natural language information for technical support into a support summary using language model.

### BACKGROUND

Users in need of technical support often have multiple interactions with support providers, both in the course of resolving or attempting to resolve a single issue, and more broadly over the course of a history of support interactions. Users can experience the same or related issues on multiple occasions, or issues for which a common set of facts are relevant. In many instances, at least some interactions between support providers and users take the form of automated troubleshooting or information collection wherein a user is prompted to answer questions (or provide information, more broadly) relevant to their support issue. In instances where automated support tools are unavailable or insufficient to address user needs or questions, a support query issue can be escalated to a human technician. In many cases, support technicians record notes on issues, tests, dispositions, and other information relevant to current and/or future support issues while or after attempting to address support issues. These notes can be useful for future tech support, especially when a different support technician may be involved.

When a human support technician is first introduced to a support issue, it is common for that technician to review at least a portion of prior user interactions, technician notes, and other user- or project-specific information to best assess and address the new support issue. This review process is time consuming and vulnerable to human error, especially when the support technician must attempt to extract relevant information quickly from a large volume of historical data. Support technicians may repeat questions or request data that users have already provided, but doing so risks increasing user impatience and frustration.

### SUMMARY

This disclosure presents a method of generating a support summary from extracting chat information including natural language data from a support chat with a user. According to this method, tokenized language is generated by tokenizing the natural language data. This tokenized language is subjected to sentiment analysis to produce sentiment data reflecting sentiment of the support user during the support chat, and to semantic analysis to extract support-relevant features. A support summary made up of natural language text identifying a support issue and information germane to the support issue is then generated from the extracted chat information using a language model, at least in part from the extracted support-relevant features and the sentiment data.

This disclosure also presents a system for generating a support summary from a natural language chat record of a support interaction with a support user. This support summary includes natural language text identifying a support problem and information germane to the support issue. The system includes a tokenization module, a sentiment extraction module, a semantic analysis module, and a language model. The tokenization module is configured to tokenize the natural language chat record, and the sentiment identification module is configured to produce sentiment data reflecting sentiment of the support user during the support interaction from the tokenized natural language chat record. The semantic analysis module is configured to extract support-relevant features from the tokenized natural language chat record, the support-relevant features including at least one support topic. The language model is configured to generate the support summary from the support-relevant features and the sentiment data.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic module diagram of a first system for generating a support summary.

FIG. 2 is a schematic module diagram of a second system for generating a support summary.

FIG. 3 is a flowchart of a method for generating the support summary using the first or second systems.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

The present disclosure provides multiple embodiments of systems and an accompanying generalizable method for improving technical support by producing a support summary for review by support technicians before and while assisting users with support issues. Specifically, this support summary is a natural language report of support-relevant information generated using a language model from semantic and sentiment analyses of historical text data (including user chat data). This historical text data can include chat transcripts from human and/or automated support chats with the user requesting technical assistance. By collecting and distilling data from prior user interactions into a summary of support-relevant data, the systems and method described herein facilitate faster and more accurate catchup by the support technician with respect to information already provided by the user, improving support efficiency and reducing likelihood of user frustration or impatience.

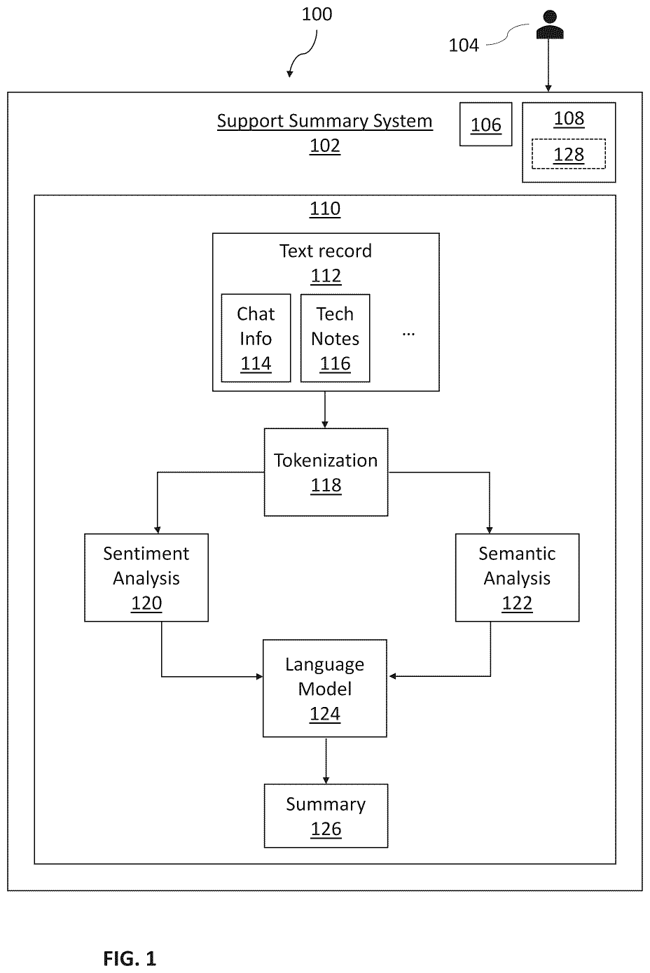

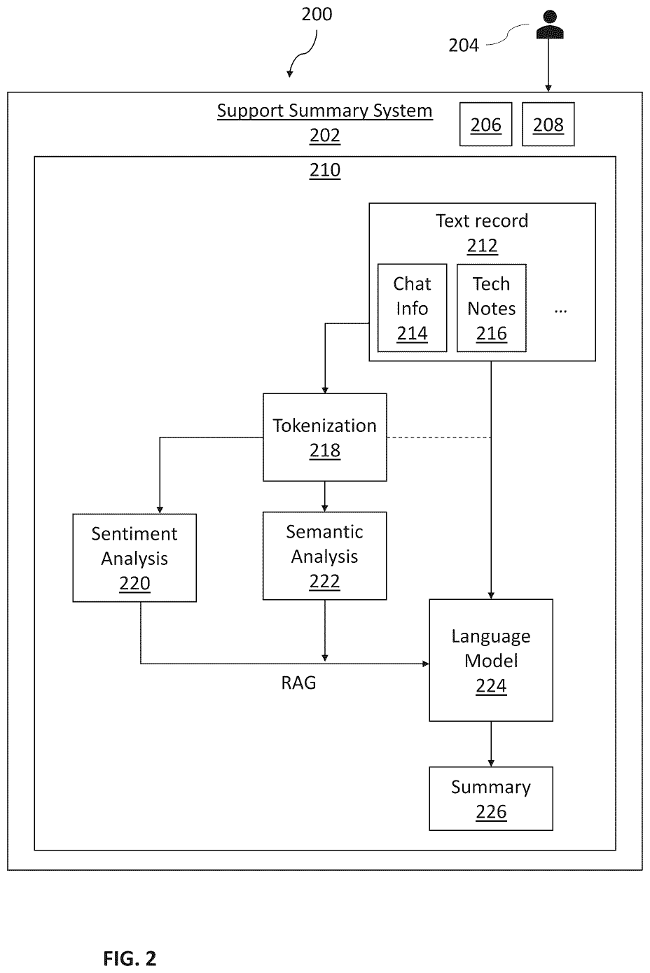

FIGS. 1 and 2 are schematic module diagrams of technical support systems 100 and 200, respectively. Technical support system 200 generally parallels technical support system 100 except where otherwise specified. More specifically, although the following description is framed largely in terms of technical support system 100, elements 2xx of technical support system 200 generally operate similarly to corresponding elements 1xx of technical support system 100, with exceptions as noted below. Where elements of FIG. 2 are not separately described, description of corresponding elements of FIG. 1 may be presumed to carry over.

Technical support system 100 includes support summary system 102 accessible to human operators 104 and including processor 106, user interface 108, and memory 110. Human operators 104 can includes support technicians, support-seeking users, and others (e.g. system administrators) who provide information used by, or receive information generated by, support system 102 via user interface 108. Support system 102 is a system capable of generating a summary of support-relevant information from historical data, as described above. Although only a single support summary system 102 is illustrated in FIG. 1, some embodiments of support system 102 can include multiple parallel modules instantiated or distributed across separate hardware.

User interface 108 is an input and/or output device and/or software interface, and enables human operator 104 to input and/or output data and/or otherwise interact with support summary system 102. For example, user interface 108 can be configured to receive text inputs from a support user including support chat, and to provide a support technician with a support summary generated by support summary system 102. In some embodiments user interface 108 can include one or more direct input/output devices facilitating input and/or output of information in a form understandable to users and/or machines, such as a sound card, a video graphics card, a speaker, a display device (such as a liquid crystal display (LCD), a light emitting diode (LED) display, an organic light emitting diode (OLED) display, etc.), a touchscreen, a keyboard, a mouse, or a joystick. In further embodiments, user interface 108 can additionally or alternatively include one or more wired or wireless transceivers capable of receiving digital communications generated via such input/output devices. More specifically, in the illustrated embodiment user interface 108 can optionally include audiovisual capture 128 such as a camera and/or microphone. For the purposes of this description, audiovisual capture 128 enables user interface 108 to record voice and/or facial expression information of a support user, as noted below.

Processor 106 is a logic-capable device or group of devices capable of executing software, applications, and/or programs stored on memory 110. Examples of processor 106 can include one or more of a processor, a microprocessor, a controller, a digital signal processor (DSP), an application specific integrated circuit (ASIC), a field-programmable gate array (FPGA), or other equivalent discrete or integrated logic circuitry. Processor 106 can be entirely or partially mounted on one or more circuit boards.

Memory 110 is a machine-readable storage medium or media configured to store information and accessible to processor 106. In some examples, a machine-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 110 is or includes a temporary memory. As used herein, a temporary memory refers to a memory having a primary purpose that is not long-term storage. In an exemplary embodiment, at least a portion of memory 110 is described as volatile memory. As used herein, a volatile memory refers to a memory that that the memory does not maintain stored contents when power to the Memory 110 is turned off. Examples of volatile memories can include random access memories (RAM), dynamic random access memories (DRAM), static random access memories (SRAM), and other forms of volatile memories. In the illustrated embodiment, memory 110 is used to store program instructions for execution by processor 106, and is used by software and/or applications running on support summary system 102 to temporarily store information during program execution.

In some embodiments memory 110 can also include non-volatile machine-readable memory for long-term storage of information. Examples of such non-volatile storage elements can include, for example, magnetic hard discs, optical discs, floppy discs, flash memories, or forms of electrically programmable memories (EPROM) or electrically erasable and programmable (EEPROM) memories. Although memory 110 is illustrated in FIG. 1 as a single module situated within support summary system 102, this module can be distributed across multiple physical locations, and long-term storage elements of memory 110 can include cloud-accessible data storage. In at least some examples, memory 110 can house support-relevant information stored in databases. For example, data stored in memory 110 can be structured in relational databases and can organize data using a relational database management system (RDBMS), object-relational database management system (ORDBMS), columnar database management systems (CDBMS), document-oriented database management systems (DoDBMS) and/or a multi-model database management system (MMDBMS), among other options.

FIG. 1 illustrates several modules of support summary system 110 implemented in memory 110 by processor 106, including text record 112, tokenization module 118, sentiment analysis module 120, semantic analysis module 122, language model 124, and summary output 126. These modules constitute specific data sets (text record 112, summary output 126) and/or software program components (tokenization module 118, sentiment analysis module 120, semantic analysis module 122, language model 124) instantiated in memory 110 and defined functionally for the sake of this description.

Text record 112 is an archive of text processed by support summary system 102 to generate a support summary for consumption by a support technician. Text record 112 can, for example, include chat information 114, technical notes 116, and other text-based information. Chat information 114 can, for example, constitute one or more transcripts of natural language chat between a support user and an automated system, a support technician, or both. Chat information 114 can include text strings provided as text by a support user and support technician or automated tool. In further embodiments, some or all of chat information 114 can consist of a text transcript of audio or video chat with the support user. In some embodiments chat information 114 can include only recent chat, e.g. a natural language transcript of chat directed to a current support issue. In other embodiments chat information 114 can also include older historical chat records potentially reflecting separate (and potentially already resolved) support issues. Chat information 114 can include user identifications of current support issues requiring resolution, i.e. questions or problems with which the support user seeks assistance from technical support system 100. Such identifications need not be explicitly separated from other chat information 114. Text record 112 can also include technical notes 116 recorded by one or more support technicians while or after providing support assistance to the support user, e.g. to summarize open questions, actions taken or pending, possible and excluded support diagnoses, and other commentary. In some embodiments technical notes 116, like chat information 114, can take the form of natural language text related to a current technical support issue, or related to older historical technical support issues which may have already been resolved. In additional to records of natural language, text record 112 can include timestamps (i.e. dates and times) associated with each record (i.e. each chat message, support note, or other text input received via input device 108). In some embodiments, some or all records can also be labeled with related information, such as names and/or roles of participants (e.g. specific support technicians or users) or the status of a related support ticket (i.e.

open or closed). Aside from this labeling, however, the contents of text record 112 can be principally strings of natural language.

Tokenization module 118 is a pre-processing tool configured to extract semantically significant text from the contents of text record 112. Specifically, each chat message, note, or other text element is tokenized, i.e. broken down into parts of speech (noun, verb, adverb, etc.) based on words and structure. Conjunctions and articles can then, in some embodiments, be discarded. Each remaining word is then stemmed, i.e. truncated to its root word—“running” to “run,” for example. These tokenized, stemmed words are then filtered to remove stop words or phrases, i.e. phrases that are merely responsive rather than additive to the semantic content of the selected portion of conversation. Stemming, tokenizing, and stop word removal can be performed using known approaches, e.g. with publicly available libraries such as the StanfordNLP Python library made available by the Stanford Natural Language Processing group. In some exemplary embodiments, the extraction of relevant text can include simplification and potentially tokenization of idiomatic language or non-textual semantic content such as emojis and/or stamps, e.g. by reference to an incorporated library or libraries (not separately shown) also present in memory 110. In some embodiments, preprocessing performed by tokenization module 118 can also include noise removal, lowercasing, normalization, and/or lemmatization. Regardless of the particular model(s) used, tokenization module 118 transforms natural language from text record 112 into tokenized language.

Tokenized language generated by tokenization module 118 is evaluated by sentiment analysis module 120. Sentiment analysis module 120 assigns a user sentiment to elements of chat information 114, i.e. to some or each chat information record. User sentiment can, for example, be binary (i.e. positive/negative) or trinary (positive/negative/neutral), and/or can include additional qualitative characterizations of apparent user sentiment (e.g. angry, frustrated, relieved). In a non-limited example, sentiment identification can be performed using VADER NLTK or textblob semantic labeling. In some embodiments video and/or audio of support user interactions can also be captured via audiovisual capture 128 and used to supplement identification of user sentiment, e.g. by facial expression recognition, voice waveform and/or spectrogram analysis, and other means known in the art. Where chat information 114 and/or audiovisual information is timestamped, sentiment analysis 120 can also identify sentiment transitions representing changes in user sentiment (e.g. positive-to-negative, frustrated-to-relieved) associated with particular text chat information records. In an illustrative example, sentiment analysis module 120 may label initial user chat records as displaying negative sentiment, reflecting user frustration or anxiety related to the support issue prompting the request for technical support. After resolution of this issue, subsequent user sentiment may shift to positive, reflecting user satisfaction or relief. In this example, sentiment analysis module 120 is capable of flagging the negative-to-positive sentiment transition associated with the message and timestamp corresponding to the resolution of the support issue.

In some embodiments support summary system 102 can also include semantic analysis module 122. Semantic analysis module 122 is an NLP-based filter capable of evaluating tokenized language provided by tokenization module 118 to identify support-relevant features and/or exclude support-irrelevant features, i.e. to distinguish information germane to potential support issues based on semantic content. Semantic analysis module 122 can, for example, perform topic modelling or topic classification based on supervised or unsupervised machine learning. In an illustrative embodiment, semantic analysis module 122 only evaluates relevance to technical support topics generally, and does not filter text based on identification of any specific support issue. In this embodiments, semantic analysis module 122 might, for example, identify a side conversation regarding sports or a pet as not germane to support topics. In another embodiment, semantic analysis module 122 can be configured to flag specific tokenized language provided by tokenization module 118 as either (1) identifying a possible support issue; or (2) related to an identified support issue. Semantic analysis module 122 can, for example, be a tokenization module configured to identify semantic features within tokenized language by means of feature extraction techniques such as bag-of-words (BOW) analysis, bag-of-n-grams analysis, term frequency-inverse document frequency (TF-IDF) vectorization analysis, One Hot encoding, or other known techniques. These features can, for example by highly predictive or support relevant features, where semantic analysis module 122 is training via supervised or unsupervised machine learning to identify “key” support features within text.

Support summary system 102 also includes language model 124. While support summary system 202 has not been separately described, elements of technical support system 200 generally mirror corresponding elements of technical support system 100 described up to this point. As noted below, however, language model 224 functions somewhat differently in support summary system 202 from language model 124 in support summary system 102. Both language model 124 and language model 224 generate a summary of a support issue and information germane to the support issue in the form of a natural language text provided as summary output 126/226.

Language models 124/224 include one or more computer-implemented machine learning models configured to generate natural language text data in response to language inputs. The computer-implemented machine learning model(s) of language models 124/224 can be referred to as a generative AI. In some examples, language models 124/224 are large language models trained at least in part through semi-supervised or self-supervised learning on large quantities of human-generated text. Where language models 124/224 are large language models, language model 160 can be, for example, a deep learning model, such as a deep neural network. It at least some examples, language models 124/224 are trained transformer models or transformer networks.

As illustrated in FIG. 1, language model 124 receives tokenized language extracted from text record 112 as processed through sentiment analysis 120 (to assign sentiment values to tokenized text) and semantic analysis 122 (to identify support-relevant features). Thus, language model 124 generates summary output 126 on the basis of tokenized text with labeling provided by these analysis modules. In some embodiments of support summary system 102, language model 124 need not be capable of ingesting natural language, and serves only to assemble a natural language summary of tokenized text information tagged or labeled based on the outputs of sentiment and semantic modules 120, 122. Labeling by sentiment analysis module 120 can, for example, flag text associated with positive or negative emotional states of the user, or with sentiment transitions potentially indicative of resolutions or problems during communication with the user. User sentiment can also be summarized directly in summary output 126 (e.g. “user has grown increasingly frustrated”) for provision to the support technician. Labeling by semantic analysis module 122 can, for example, identify text data for inclusion in or exclusion from summary output 126 based on general support relevance or relevance to specific support issues.

As illustrated in FIG. 2, language model 224 receives natural language from text record 212 (with or without text tokenization by tokenization module 218), and assembles summary output 226 directly therefrom. To assist language model 224 in identifying support issues and information germane to those issues, sentiment outputs from sentiment analysis module 220 and support-relevance outputs from semantic analysis module 222 can be supplied to language model 224 for retrieval-augmented generation (RAG) or other forms of context injection, to define boundary conditions or otherwise constrain outputs of language model 224. In particular, sentiment analyses from sentiment analysis module 220 can be used to flag transformative interactions from within chat information 214 on the basis of detected sentiment or transitions in sentiment, and semantic analyses from semantic analysis module 222 can be used to flag specific support issues and information germane thereto. Although tokenization modules 118/218, sentiment analysis modules 120/220, semantic analysis modules 122/222, and language models 124/224 are presented herein as discrete components of support summary system 102/204, the functions represented by these components can in some embodiments be performed together, or in different orders. Functions of sentiment analysis modules 120/220 and semantic analysis modules 122/222, for example, can be performed in parallel (as shown) or in series, in any order. Similarly, though sentiment and semantic analysis modules 120/220 and 122/222 are illustrated as separate from language models 124/224, some embodiments of support summary systems 102/202 may integrate semantic and/or sentiment analysis into a single generative AI trained to incorporate semantic and/or sentiment analyses generally as described above.

Summary output 126 or 226, produced by language model 124 or 224, respectively, provides a summary in natural language of support-relevant portions of text record 112. Support output 126/226 is tailored to distil information for a support technician so as to allow the technician to quickly become familiar with any technical issues and relevant information already captured in text record 112/212 before and while engaging a user to provide technical support. By so doing, technical support systems 100/200 shorten times and avoid repetitions in technical support resolutions for both users and technicians, improving technician efficiency and improving user satisfaction with the technical support process.

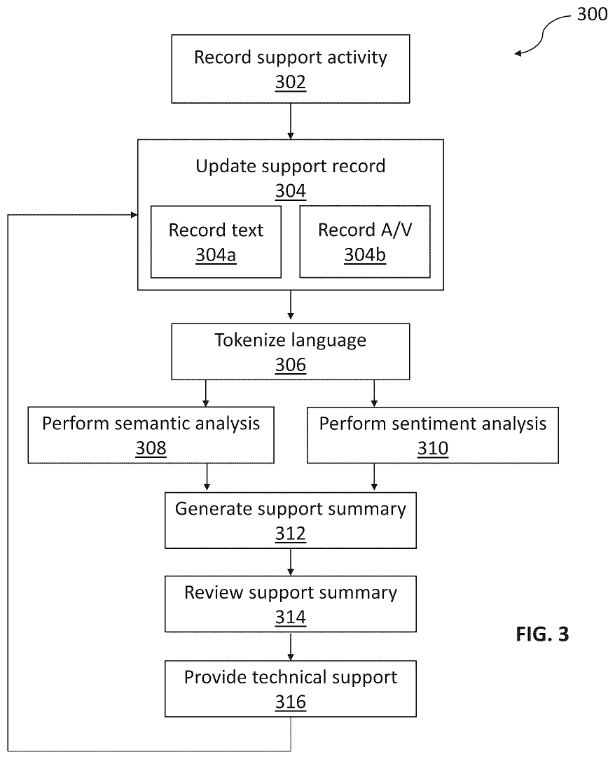

FIG. 3 is a method flowchart and serves mainly as a recap of tech support methods already discussed above. Specifically, FIG. 3 illustrates support method 300 for generating and using support summaries using technical support systems 100 and/or 200.

As described above, support activity reflecting user interactions and other support-relevant information is received via user interface 108/208 and recorded in memory 110/210 (Step 302), and used to update a support record (Step 304). More specifically, text record 112/212 is updated to include natural language chat text between the user and an automated support system and/or human technician is recorded in memory 110/210. (Step 304a) In some embodiments, audio and/or video data of support interactions with the user can also be recoded, e.g. for transcription into text for text record 112/212 and/or for analysis of user sentiment. (Step 304b). Natural language in text record 112/212 is then tokenized by tokenization module 118/218. (Step 306). For each support chat record, this tokenized language is used by semantic analysis module 122/222 to generate content-based relevance assessments (Step 308), and by sentiment analysis module 120/220 to generate identifications of associated sentiment (Step 310). Language model 124/224 produces a support summary as described above using the sentiment identifications provided by sentiment analysis module 120/220 and the relevance analysis generated by semantic analysis module 122/222, the tokenized text produced by tokenization module 118/218, and in some embodiments (see FIG. 2) the natural language support chats recorded in chat information 214 of text record 212. A support technician reviews this support summary (Step 314) and provides technical support to the user, accordingly (Step 316). During and after providing technical support, the support record may be updated again to reflect the additional text (and audiovisual information, if available) from this support interaction, and to reflect technical notes and other records added manually by the support technician. This updating ensures that text record 112 remains up-to-date for future technical support relating to the same or different support issues.

As noted above with respect to FIGS. 1 and 2, the operation of technical support system 100/200 in steps 302-312 enables more efficient ingestion of historical information by a support technician, such that step 314 is simultaneously faster and more comprehensive than manual review, allowing technical support (Step 316) to proceed quickly and efficiently, without undue delay or cause for user frustration.

### Discussion of Possible Embodiments

The following are non-exclusive descriptions of possible embodiments of the present invention.

A method of generating a support summary, the method comprising: extracting chat information from a support chat with a support user via a processor, the chat information including natural language data; tokenizing the natural language data to generate tokenized language; performing sentiment analysis on the tokenized language to produce sentiment data reflecting sentiment of the support user during the support chat; performing semantic analysis on the tokenized language to extract support-relevant features; producing the support summary using a language model, wherein: the support summary comprises a natural language text identifying a support issue and information germane to the support issue, from the extracted chat information; and the language model produces the support summary at least in part from the extracted support-relevant features and the sentiment data.

The method of the preceding paragraph can optionally include, additionally and/or alternatively, any one or more of the following features, configurations and/or additional components:

A further embodiment of the foregoing method, further comprising: recording audiovisual (AV) data including audio and/or video corresponding from the support chat with the support user; and generating the sentiment identification based in part on the AV data.

A further embodiment of the foregoing method, wherein performing sentiment analysis on the AV data comprises: extracting audio waveform data from the AV data; and generating the sentiment identification based in part on the extracted audio waveform data.

A further embodiment of the foregoing method, wherein performing sentiment analysis on the AV data comprises: extracting facial expression information from the AV data; and generating the sentiment identification based in part on the facial expression information.

A further embodiment of the foregoing method, wherein the sentiment data comprises: identification of a plurality of user sentiments expressed by the support user during the support chat; and identification of a sentiment transition between the plurality of user sentiments. A further embodiment of the foregoing method, wherein the support summary includes an identification of user sentiment.

A further embodiment of the foregoing method, wherein producing the support summary using the language model comprises correlating the user sentiment and a change in the user sentiment with at least one chat string included among the chat information.

A further embodiment of the foregoing method, further comprising performing feature extraction on natural language technical notes recorded by a support technician, and the language model produces the support summary at least in part based on features extracted from the natural language technical notes.

A further embodiment of the foregoing method, wherein the language model produces the support summary at least in part from the extracted support-relevant features, the sentiment data, and the natural language data.

A further embodiment of the foregoing method, wherein the language model receives the extracted support-relevant features and the sentiment data in the form of context injection for the generative production of the support summary.

A further embodiment of the foregoing method, wherein performing semantic analysis on the tokenized language comprises classifying the tokenized language according to semantic features.

A further embodiment of the foregoing method, further comprising performing feature extraction on the chat information to flag the semantic features, wherein the feature extraction includes at least one of bag-of-words (BOW) analysis, bag-of-n-grams analysis, term frequency-inverse document frequency (TF-IDF) vectorization analysis, and One Hot encoding.

A further embodiment of the foregoing method, wherein the language model is a large language model, and wherein producing the support summary using the language model comprises generating the support summary at least in part from the extracted chat information.

A further embodiment of the foregoing method, wherein the generation of the support summary is constrained by retrieval augmented generation (RAG) using at least one of the sentiment data and the support-relevant features.

A method of providing technical support to a user, the method comprising: generating a support summary according to the foregoing method; reviewing the support summary; providing technical support related to the support issue identified in the support summary, to the user.

A further embodiment of the foregoing method, wherein the language model produces the support summary at least in part base on features extracted from natural language technical notes, the method further comprising updating the technical notes while or after providing the technical support to the user, the technical notes including at least one of open questions, actions taken or pending, and possible or excluded diagnoses.

A system for generating a support summary from a natural language chat record of a support interaction with a support user, the support summary comprising natural language text identifying a support issue and information germane to the support issue, the system comprising: a tokenization module configured to tokenize the natural language chat record; a sentiment identification module configured to produce sentiment data from the tokenized natural language chat record, the sentiment data reflecting sentiment of the support user during the support interaction; a semantic analysis module configured to extract support-relevant features from the tokenized natural language chat record; and a language model configured to generate the support summary from the support-relevant features and the sentiment data.

The system of the preceding paragraph can optionally include, additionally and/or alternatively, any one or more of the following features, configurations and/or additional components:

A further embodiment of the foregoing system, wherein the support-relevant features include at least one support issue, and the support summary identifies the support issue.

A further embodiment of the foregoing system, wherein the language model is a large language model configured to generate the support summary from the natural language chat record using the sentiment data and the support-relevant features for context injection.

A further embodiment of the foregoing system, further comprising an audiovisual capture device configured to capture audio or video data corresponding to the support interaction with the support user, wherein the sentiment identification is configured to produce the sentiment data at least in part from the captured audio or video data.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of generating a support summary, the method comprising:
extracting chat information from a support chat with a support user via a processor, the chat information including natural language data;
tokenizing the natural language data to generate tokenized language;
performing sentiment analysis on the tokenized language to produce sentiment data reflecting sentiment of the support user during the support chat;
performing semantic analysis on the tokenized language to extract support-relevant features;
producing the support summary using a language model, wherein:
the support summary comprises a natural language text identifying a support issue and information germane to the support issue, from the extracted chat information; and
the language model produces the support summary at least in part from the extracted support-relevant features and the sentiment data.

2. The method of claim 1, further comprising:
recording audiovisual (AV) data including audio and/or video corresponding from the support chat with the support user; and
generating the sentiment identification based in part on the AV data.

3. The method of claim 2, wherein performing sentiment analysis on the AV data comprises:
extracting audio waveform data from the AV data; and
generating the sentiment identification based in part on the extracted audio waveform data.

4. The method of claim 2, wherein performing sentiment analysis on the AV data comprises:
extracting facial expression information from the AV data; and
generating the sentiment identification based in part on the facial expression information.

5. The method of claim 1, wherein the sentiment data comprises:
identification of a plurality of user sentiments expressed by the support user during the support chat; and
identification of a sentiment transition between the plurality of user sentiments.

6. The method of claim 1, wherein the support summary includes an identification of user sentiment.

7. The method of claim 1, wherein producing the support summary using the language model comprises correlating the user sentiment and a change in the user sentiment with at least one chat string included among the chat information.

8. The method of claim 1, further comprising performing feature extraction on natural language technical notes recorded by a support technician, and the language model produces the support summary at least in part based on features extracted from the natural language technical notes.

9. The method of claim 1, wherein the language model produces the support summary at least in part from the extracted support-relevant features, the sentiment data, and the natural language data.

10. The method of claim 9, wherein the language model receives the extracted support-relevant features and the sentiment data in the form of context injection for the generative production of the support summary.

11. The method of claim 1, wherein performing semantic analysis on the tokenized language comprises classifying the tokenized language according to semantic features.

12. The method of claim 11, further comprising performing feature extraction on the chat information to flag the semantic features, wherein the feature extraction includes at least one of bag-of-words (BOW) analysis, bag-of-n-grams analysis, term frequency-inverse document frequency (TF-IDF) vectorization analysis, and One Hot encoding.

13. The method of claim 1, wherein the language model is a large language model, and wherein producing the support summary using the language model comprises generating the support summary at least in part from the extracted chat information.

14. The method of claim 13, wherein the generation of the support summary is constrained by retrieval augmented generation (RAG) using at least one of the sentiment data and the support-relevant features.

15. A method of providing technical support to a user, the method comprising:
generating a support summary according to the method of claim 1;
reviewing the support summary;
providing technical support related to the support issue identified in the support summary, to the user.

16. The method of claim 15, wherein the language model produces the support summary at least in part base on features extracted from natural language technical notes,
the method further comprising updating the technical notes while or after providing the technical support to the user,
the technical notes including at least one of open questions, actions taken or pending, and possible or excluded diagnoses.

17. A system for generating a support summary from a natural language chat record of a support interaction with a support user, the support summary comprising natural language text identifying a support issue and information germane to the support issue, the system comprising:
a tokenization module configured to tokenize the natural language chat record;
a sentiment identification module configured to produce sentiment data from the tokenized natural language chat record, the sentiment data reflecting sentiment of the support user during the support interaction;
a semantic analysis module configured to extract support-relevant features from the tokenized natural language chat record; and
a language model configured to generate the support summary from the support-relevant features and the sentiment data.

18. The system of claim 17, wherein the support-relevant features include at least one support issue, and the support summary identifies the support issue.

19. The system of claim 17, wherein the language model is a large language model configured to generate the support summary from the natural language chat record using the sentiment data and the support-relevant features for context injection.

20. The system of claim 17, further comprising an audiovisual capture device configured to capture audio or video data corresponding to the support interaction with the support user, wherein the sentiment identification is configured to produce the sentiment data at least in part from the captured audio or video data.
